(19) United States
(12) Patent Application Publication
(10) Pub. No.: US 2006/0265325 A1
(43) Pub. Date: Nov. 23, 2006

(54) System and method for facilitating payment via a communications network using value accredited to a customer of the communications network

(76) Inventor: Alfredo C. Fajardo, Manila (PH)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/567,957

(22) PCT Filed: Apr. 14, 2004
(86) PCT No.: PCT/SG04/00088

§ 371 Date: Feb. 10, 2006

(30) Foreign Application Priority Data
Dec. 18, 2003 (SG) 200307551-2
Dec. 18, 2003 (SG) 200401181-3

(51) Int. Cl. G06Q 40/00

(52) U.S. Cl. 705/40

(57) ABSTRACT

A system for facilitating payment (10) via a communications network (12) using value accredited to a customer (14) of the communications network (12), the system comprising a first communications device (22) owned and/or operated by the customer (14); a recipient (16); a billing system (18) associated with the communications network least one account (30) recorded with the billing system (18); and a payments facilitator (20), wherein, when the payments facilitator (20) receives a communications message (32) from the customer (14) identifying the recipient (16) and the amount to be paid to the recipient (16), the communications message (32) being sent by means of the first communications device (22), the payments facilitator (20) operates to command the billing system (18) to debit the amount to be paid to the recipient (16) from the customer's (14) at least one account (30) and thereafter, operates to command the billing system (18) to credit the amount to be paid to the recipient (16) to the recipient's (16) at least one account (30). Ideally, the command to the billing system (18) to debit the amount to be paid takes the form of a command representative of the customer (14) having made a call on a line having a tariff rate closest to the amount to be paid to the recipient (16). In determining the tariff rate closest to the amount to be paid to the recipient (16), the payments facilitator (20) may refer to a tariff look-up table (34) comprising details of all tariff rates presently set by an operator of the communications network (12).

### FIELD OF THE INVENTION

The present invention relates to a system and method for facilitating payment via a communications network using value accredited to a customer of the communications network. The invention is particularly, but not exclusively, adapted to:
facilitate the transfer of credit from the account of a first mobile phone user to the account of a second mobile phone user using the communications network of a carrier common to both users; and
facilitate the transfer of credit from the account of the first mobile phone user to the account of a merchant accredited by the carrier.

### BACKGROUND ART

The following discussion of the background of the invention is intended to facilitate an understanding of the invention. However, it should be appreciated that the discussion is not an acknowledgement or admission that any of the material referred to was published, known or part of the common general knowledge of the person skilled in the art in any jurisdiction as at the priority date of the application.

Telecommunication carriers have, in recent years, expanded to provide premium data services and value-added services, such as downloadable ringtones and logos. These services are charged to the end-user by means of the carrier's billing system.

Each carrier's billing system is, at its generic level, configured to:
debit from a customer's account with the carrier an amount equal to the cost of a call made by the customer or premium data service or value-added service received by the customer (as determined by the applicable tariff rate defined by the carrier for the call or service); and
add credit to a customer's account with the carrier on receipt of a payment, which may be a pre- or post-payment.

The problem with this arrangement is that third parties wanting to provide services to customers of the carrier must directly access the carrier's billing system to co-ordinate payment. This is an unlikely proposition, however, as allowing a third party direct access to a carrier's billing system raises security and implementation issues. Most notably, allowing third party access to a carrier's billing system opens the billing system up to exploitation and/or malicious use by external people who may, or may not, be associated with a third party authorised to directly access the carrier's billing system.

An additional problem with billing systems as described above, is that such billing systems are not configured to handle situations where a first customer wishes to transfer a credit amount to a second customer without need to expressly notify the carrier that such a transaction is to take place.

Accordingly, it is an object of the present invention to provide a system and method for facilitating payment via a communications network where one or both of the aforementioned problems are overcome through appropriate manipulation of the carrier's existing billing system without need of modification. This can be achieved by receiving or sending a communications message with a corresponding or defined tariff and using the debited amount to credit another user or merchant account other than that of the operator. The defined tariff of the communications message may be determined by the details (ie. a number or number word) recorded in the communications message.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the present invention there is a system for facilitating payment via a communications network using value accredited to a customer of the communications network, the system comprising:
a first communications device owned and/or operated by the customer;
a recipient;
a billing system associated with the communications network, both the customer and the recipient having at least one account recorded with the billing system; and
a payments facilitator,
   where, when the payments facilitator receives a communications message from the customer, the communications message being sent by means of the first communications device, the payments facilitator operates to instruct the billing system to debit an amount to be paid to the recipient from the customer's at least one account and operates to instruct the billing system to credit the amount to be paid to the recipient to the recipient's at least one account.

In a first alternative arrangement, the communications message may omit either the details identifying the recipient or the amount to be paid. These details can then be obtained by other sources such as the intended destination or conveyance medium of the communications message. For example, a plurality of phone lines or short codes, each representing a different monetary amount, may be used, to transfer funds between customer and recipient. Alternatively, the customer may enter the amount or telephone number as a suffix to a pre-specified destination (such as a shortcode telephone number or e-mail address) with the payments facilitator operative thereafter to parse the information and thereby obtain the entered amount or telephone number.

In a second alternative arrangement, the customer may send a communications message that merely specify the details of the recipient—the amount to be transferred thereafter being provided by the intended recipient after receiving details of the proposed transfer from the payments facilitator. In this arrangement, the payments facilitator may request that the customer confirm transfer of the amount specified by the intended recipient is acceptable to them. This may, optionally, involve the customer sending a communications message to the payments facilitator with a personal identification number or other details as set by the agreed security procedure to the payments facilitator. Such confirmation may also need to be attended to within a pre-determined time period in order for the transfer to proceed.

Ideally, the instruction to the billing system to debit the amount to be paid takes the form of a command representative of the customer having made a call on a line having a tariff rate closest to the amount to be paid to the recipient. In determining the tariff rate closest to the amount to be paid to the recipient, the payments facilitator may refer to a tariff look-up table comprising details of all tariff rates presently set by an operator of the communications network.

Furthermore, the instruction to the billing system to credit the amount to be paid to the recipient takes the form of a command representative of the recipient having made a payment, whether pre- or post-payment, equal to the amount to be paid to the recipient. In this manner, payment can be made in the form of a transfer of funds from one party to another in addition to general payments for goods and/or services provided by merchants. In later arrangements, the payments facilitator modifies its processing to instruct the billing system to debit the amount to be paid to the recipient from the customer's at least one account and, thereafter, operates to instruct the billing system to credit the amount to be paid to the payments facilitator's account. The payment facilitator thereafter operates to make payment to the recipient via other means, such as electronic transfer or legal tender.

The communications network can take a variety of forms, such as mobile phone networks or data communications networks like the Internet. Similarly, the communications message may take such forms as Short Message Service (“SMS”) messages or e-mail messages. In the same vein, communication devices may take such forms as mobile phones, fixed phones, pagers or computers, amongst others. This allows the invention to be applied for use in a variety of communication networks.

This also allows the communications message to be replaced by other systems. For example, the customer can enter details of the intended recipient and/or amount to be transferred by voice or telephone keypad. In the former arrangement, the payments facilitator is required to be able to convert the speech into a format acceptable for further processing. In the latter arrangement, the payments facilitator is required to be able to convert the set of DTMF tones into a format acceptable for further processing as would be known to the person skilled in the art. Additionally, in such latter arrangement the customer maybe prompted to enter in the details or may be able to provide such details automatically using a separator character (e.g “*” or “#”) to distinguish one component of the required details from another.

In a preferable embodiment, the recipient also has a communications device. In such arrangements, the customer and recipient are able to be identified by means of the unique identifiers assigned to each communication device. Additionally, automatic caller identification, or similar mechanisms, can be used to establish the unique identifier of the customer's communications device.

Preferably, the payments facilitator parses the communications message to separately identify its operative components. The communications message may include optional components that:
identify that the communications message is the initiator of a payment of funds from at least one of the customer's accounts;
identify which of the customer's accounts from which the amount is to be transferred;
identify which of the recipient's accounts to which the amount is to be transferred; and/or
identify the method of payment to the recipient.

Ideally, the customer is given some flexibility in how they wish to describe the amount to be transferred from within the communications message. For example, the customer should be allowed to enter the amount in either numerical or textual representation.

The instruction issued to the billing system may also vary in format. For example, the instruction may take the same formats as are available for the communications message. Furthermore, both the instructions and communications message may be encrypted.

In a highly preferred embodiment, the payments facilitator operates to command the billing system to debit a further amount from the customer's account representative of commissions and/or transaction costs. The amount representative of commissions and/or transaction costs may vary dependent on such factors as the amount value, the recipient and/or method of payment. The payment facilitator may combine the commands to debit the amount to be paid to the recipient and the further amount from the customer's account by way of a single command.

The invention should also provide, in an advantageous configuration, for the tariff look-up table to be automatically updated in the event of a change in any of the tariff rates defined by the carrier. This can be attended to easily if the payments facilitator and billing system form part of a larger system of the carrier, although this is not essential to obtain the advantageous configuration described.

In accordance with a second aspect of the invention there is a payments facilitator for use within a system for facilitating payment via a communications network using value accredited to a customer of the communications network, the system comprising:
a first communications device owned and/or operated by the customer;
a recipient; and
a billing system associated with the communications network, both the customer and the recipient having at least one account recorded with the billing system;
   where the payments facilitator, upon receipt of a communications message from the customer, the communications message being sent by means of the first communications device, operates to instruct the billing system to debit the amount to be paid to the recipient from the customer's at least one account and operates to instruct the billing system to credit the amount to be paid to the recipient to the recipient's at least one account.

In an advantageous arrangement, the instruction given by the payments facilitator to the billing system to debit the amount to be paid takes the form of a command representative of the customer having made a call on a line having a tariff rate closest to the amount to be paid to the recipient. In determining the tariff rate closest to the amount to be paid to the recipient, the payments facilitator may refer to a tariff look-up table comprising details of all tariff rates presently set by an operator of the communications network. Further, the payments facilitator may be configured to automatically update the tariff look-up table in the event of a change in any of the tariff rated defined by the carrier.

Additionally, the instruction to the billing system to credit the amount to be paid to the recipient takes the form of a command representative of the recipient having made a payment, whether pre- or post-payment, equal to the amount to be paid to the recipient.

In a yet further arrangement, the payments facilitator may, upon instructing the billing system to debit the amount to be paid to the recipient from the customer's at least one account, operate to instruct the billing system to credit the amount to be paid to the payments facilitator's account. The payment facilitator thereafter operates to make payment to the recipient via other means, such as electronic transfer, cheque or legal tender. The payments facilitator may use techniques such as automatic caller identification, or similar mechanisms, to establish the unique identifier of the customer's communications device, and thereby properly identify the customer's account with the carrier.

Preferably, the payments facilitator parses the communications message to separately identify its operative components.

In accordance with a third aspect of the invention there is a method for facilitating payment via a communications network using value accredited to a customer of the communications network comprising:
receiving a communications message from the customer sent by means of a first communications device operable via the communications network;
instructing a billing system associated with the communications network to debit an amount to be paid to a recipient from the customer's at least one account recorded with the billing system; and
instructing the billing system to credit the amount to be paid to the recipient to the recipient's at least one account recorded with the billing system.

The method may also include the step of communicating with the recipient to specify the amount to be paid to the recipient.

Alternatively, there is a method for facilitating payment via a communications network using value accredited to a customer of the communications network comprising:
receiving a communications message from the customer sent by means of a first communications device operable via the communications network;
instructing a billing system associated with the communications network to debit an amount to be paid to a recipient from the customer's at least one account recorded with the billing system;
instructing the billing system to credit the amount to be paid to the recipient to an account recorded with the billing system, the account being owned by a third party; and
arranging payment of the amount to be paid to be made by the third party to the recipient.

### BRIEF DESCRIPTION OF THE DRAWINGS

The invention will now be described with reference to the following drawings, of which:

FIG. 1 is a schematic diagram of a first embodiment of a system for facilitating payment via a communications network using value accredited to a customer of the communications network.

FIG. 2 is a schematic diagram of a second embodiment of a system for facilitating payment via a communications network using value accredited to a customer of the communications network.

### BEST MODE(S) FOR CARRYING OUT THE INVENTION

In accordance with a first aspect of the invention there is provided a system 10 for facilitating payment via a communications network 12 using value accredited to a first customer 14 of the communications network 12. In addition to the elements of the system 10 already identified, the system 10 further comprises:
a billing system 18;
a payments facilitator 20;
a first communication device 22;
a second customer 16; and
a second communication device 24.

The communications network 12 and billing system 18 are owned and/or operated by a carrier 28. The first communication device 22 is owned and/or operated by the first customer 14. The second communication device 24 is owned and/or operated by the second customer 16.

The billing system 18 records a plurality of accounts 30. At least one of the plurality of accounts 30 is associated with the first customer 14. At least one of the plurality of accounts 30 is associated with the second customer 24. Ideally, the association between customer 14, 16 and their account 30 is formed by the unique communication identifier assigned to the customer's 14,16 communication device 22, 24 respectively.

The first and second communication device 22, 24 are in data communication with the payments facilitator 20 via the communications network 12. The payments facilitator 20 is also in data and control communication with billing system 18. The payments facilitator 20 further incorporates a tariff look-up table 34 that includes details of all tariff rates defined by the carrier 28.

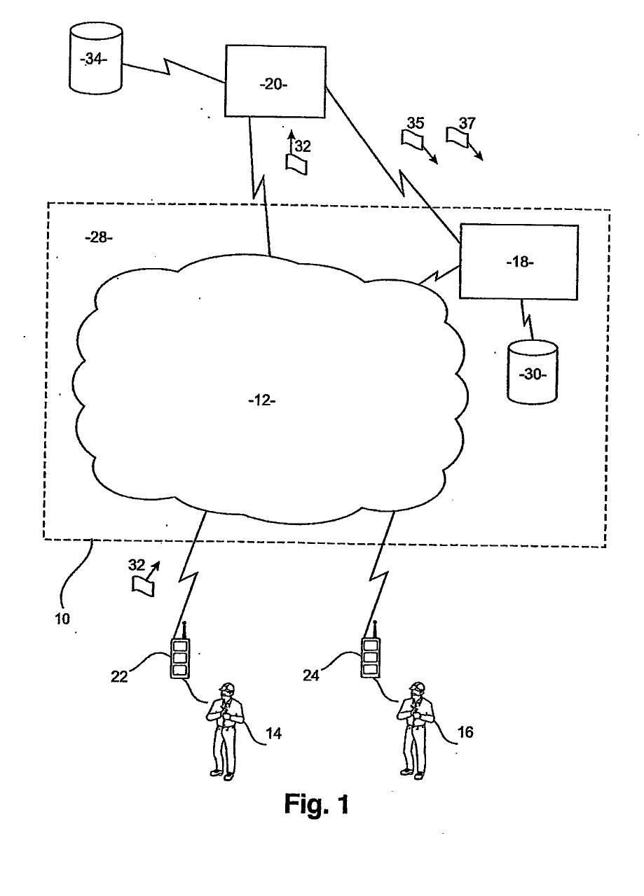

In the embodiment shown in FIG. 1, the communications network is a mobile phone network, such as a GSM network. Accordingly, first and second communication device 22, 24 are mobile phones. The unique communication identifiers assigned to the first and second communication device 22, 24 are their respective assigned mobile phone numbers. Additionally, tariff look-up table 34 includes details of all tariff rates defined by the carrier 28 for mobile terminating (“MT”) charges.

The system will now be described with reference to some examples. In the first example to be described, first customer 14 is desirous of transferring credit from one of his associated accounts 30 to an associated account 30 of second customer 16.

To initiate the transfer, first customer 14 sends a communications message 32, in the form of a SMS message, to the payments facilitator 20. The communications message 32 is required to comply with the following format:
SEND Amount><Target Communication Device Identifier>

The <Amount> component of the communications message 32 can be either a numerical representation or a textual representation of the amount to be transferred. For example, “25” or “twenty-five” can be used to indicate that an amount of $25 is intended to be transferred to the account associated with the target communication device identifier.

The <Target Communication Device Identifier> component of the communications message 32 is the unique communication identifier of the second communication device 24. For example, 0917 893 0986.

On receipt of the communications message 32, the payments facilitator 20 parses the communications message 32 to determine its component parts. Accordingly, upon completion of the parsing operation, the payments facilitator 20 has separately identified the <Amount> value and the <Target Communication Device Identifier>. Through automatic caller identification, the unique communication identifier of the first communication device 22 is also established.

Payments facilitator 20 then operates to convert the <Amount> value into a format that provides for comparison to the various tariff rates defined by the carrier 28 that are stored in the tariff look-up table 34. A comparison is then made between the <Amount> value and the various tariff rates to determine the closest tariff rate to the <Amount> value. A charge to the first customer's 14 account 30 with the carrier 28 (as determined through the unique communication identifier established via the automatic caller identification technique) is then made by the payments facilitator 20 by initiating a command 35 to the billing system 18 representative of the first customer 14 having made a call on a line having the tariff rate closest to the Amount> value.

Once the first customer's 14 account 30 has been appropriately charged, the payments facilitator 20 then operates to credit the second customer's 24 account 30. This is achieved by, firstly, matching the <Target Communication Device Identifier> with the unique communication identifier of the second customer's 24 account 30. Thereafter, a command 37 is initiated to the billing system 18 representative of the second customer 24 having made a payment, whether pre- or post-payment, equal to the <Amount>value on their account 30.

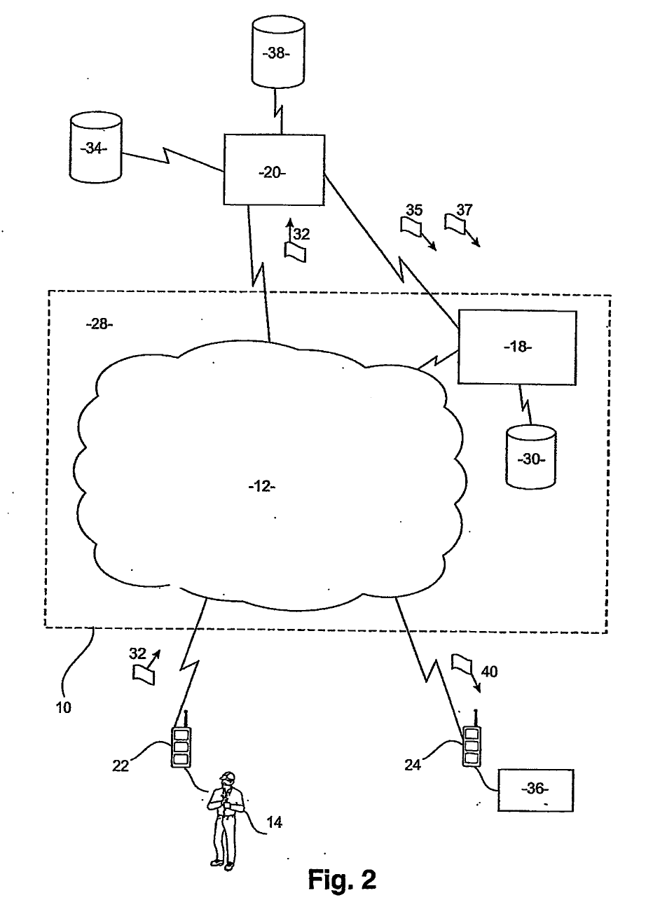

In this, the second example to be described, first customer 14 is desirous of making payment for goods and/or services provided by a merchant 36. The second example is shown graphically at FIG. 2.

To initiate the payment, first customer 14 sends a communications message 32, in the form of an SMS message, to the payments facilitator 20. The communications message 32 is required to comply with the following format:
SEND <Amount><Merchant Identifier>

The <Amount> component of the communications message 32 can be either a numerical representation or a textual representation of the amount to be transferred. For example, “25” or “twenty-five” can be used to indicate that an amount of $25 is intended to be paid to the merchant 36.

The <Merchant Identifier> component of the communications message 32 is the unique identifier of the merchant 36. For example, the <Merchant Identifier> may be the mobile phone number of the merchant 36. Alternatively, the <Merchant Identifier>may be a unique identifier assigned to the merchant 36 by the payments facilitator 20.

On receipt of the communications message 32, the payments facilitator 20 parses the communications message 32 to determine its component parts. Accordingly, upon completion of the parsing operation, the payments facilitator 20 has separately identified the <Amount> value and the <Merchant Identifier>. Through automatic caller identification, the unique communication identifier of the first communication device 22 is also established.

Payments facilitator 20 then operates to convert the <Amount> value into a monetary value. A comparison is then made between the <Amount> value and the various tariff rates to determine the closest tariff rate to the <Amount> value. A charge to the first customer's 14 account 30 with the carrier 28 (as determined through the unique communication identifier established via the automatic caller identification technique) is then made by the payments facilitator 20 by initiating a command 35 to the billing system 18 representative of the first customer 14 having made a call on a line having the tariff rate closest to the <Amount> value.

Once the first customer's 14 account 30 has been appropriately charged, the payments facilitator 20 then operates to credit it's own account 30 with the carrier 28. This is achieved by, initiating a command 37 to the billing system 18 representative of the payments facilitator 20 having made a payment equal to the <Amount> value.

The payments facilitator 20 then obtains identification details in respect of the merchant to be paid by checking a merchant look-up table 38 (<Merchant Identifier> values equating to the look-up key of the merchant look-up table 38).

Payment 40 equal to <Amount> value is then made by the payments facilitator 20 to the identified merchant 36. In this manner, the merchant can be paid in legal tender or by electronic transfer rather than in credit to his/her mobile phone account.

In yet a third example hereafter described, first customer 14 establishes communication with the payment facilitator 20 using a pre-determined telephone number. An automated system (not shown) of the payment facilitator operates to prompt the first customer 14 to enter in a unique communication identifier for the intended recipient of the amount to be transferred. The first customer 14, can then enter in such details by voice or by using the telephone keypad.

Regardless of the method used to enter in the details, the automated system is adapted to convert the speech or set of DTMF tones into a unique communication identifier in a format native to the payments facilitator 20.

Once a unique communication identifier has been entered by the first customer 14, the automated system prompts the first customer 14 to enter-in the amount to be transferred. The first customer 14 can again enter amount details by voice or by the telephone keypad with the entered amount being converted into a format native to the payments facilitator 20.

Payments facilitator 20 then operates to compare the entered amount to the various tariff rates defined by the carrier 28 that are stored in the tariff look-up table 34 and thereby determine the closest tariff rate to the entered amount value. A charge to the first customer's 14 account 30 with the carrier 28 (as determined through the unique communication identifier established via the automatic caller identification technique) is then made by the payments facilitator 20 by initiating a command 35 to the billing system 18 representative of the first customer 14 having made a call on a line having the tariff rate closest to the entered amount value.

Once the first customer's 14 account 30 has been appropriately charged, the payments facilitator 20 then operates to credit the second customer's 24 account 30. This is achieved by, firstly, matching the entered unique communication identifier with the unique communication identifier of the second customer's 24 account 30. Thereafter, a command 37 is initiated to the billing system 18 representative of the second customer 24 having made a payment, whether pre- or post-payment, equal to the entered amount value on their account 30.

In accordance with a fourth example of the proposed system, the first customer 14 seeks to transfer an unspecified sum of money from one of his associated accounts 30 to an associated account 30 of second customer 16.

To initiate the transfer, first customer 14 sends a communications message 32, in the form of a SMS message, to the payments facilitator 20. The communications message 32 is required only to specify the unique communication identifier of the second communication device 24, ie. the device used by the second customer 16.

On receipt of the communications message 32, the payments facilitator 20 converts the communications message 32 into a format native to the payments facilitator 20. Through automatic caller identification,l the unique communication identifier of the first communication device 22 is also established.

Payments facilitator 20 then sends a communications message (not shown) to second communication device 24. This communications message informs the second customer 16 that first customer 14 (as identified by his unique communication identifier) intends to transfer money between their respective accounts 30. The communications message further requests second customer 16 to reply to the message indicating the amount to be transferred between the accounts.

On receiving the reply message from the second customer 16 (via second communication device 24), the payments facilitator 20 converts the amount into a format native to the payments facilitator.

As an optional, but preferred, step, the payments facilitator 20 sends a yet further communications message (again not shown) to the first customer 14 (via first communication device 22). This communications message includes details of the amount the second customer 16 has requested be transferred to the second customer's 16 associated account 30. The first customer 14 is then asked to respond to the communications message in a manner indicating that the transfer is to proceed with the amount to be transferred being the amount requested. This may involve the first customer including a personal identification number or details relating to some other security arrangement in the responding message. Upon confirmation, processing proceeds as follows (Confirmation may also need to be attended to within a predetermined period of time).

Payments facilitator 20 then makes a comparison between the requested amount and the various tariff rates to determine the closest tariff rate to the requested amount. A charge to the first customers 14 account 30 with the carrier 20 (as determined through the unique communication identifier established via the automatic caller identification technique) is then made by the payments facilitator 20 by initiating a command 35 to the billing system 18 representative of the first customer 14 having made a call on a line having the tariff rate closest to the requested amount.

Once the first customer's 14 account 30 has been appropriately charged, the payments facilitator 20 then operates to credit the second customer's 24 account 30. This is achieved by, firstly matching the unique communication identifier specified in communications message 32 with the unique communication identifier of the second customer's 24 account 30. Thereafter, a command 37 is initiated to the billing system 18 representative of the second customer 24 having made a payment, whether pre- or post-payment, on their account equal to the requested amount.

It should be appreciated by the person skilled in the art that the invention is not limited to the embodiments described. In particular, the inventions as described can include the following modifications and/or additions:
the invention can be modified to suit a situation where the communications network 12 is a data communications network such as the Internet. In such an arrangement it is envisaged that the first and second communication devices 22, 26 take the form of computers and the communications message 32 takes the form of an e-mail. A number of unique identifiers can then be used to identify the communication devices, however, in static IP situations, the IP address of the computer may be used as the unique identifier.
The communications message 32 may be adapted in a variety of ways, provided that as a minimum the amount to be paid and identification of the intended recipient are included in the message. For example, modifications to the communications message 32 may include:
   (i) adding component identifying which of a plurality of accounts 30 from which the first customer 14 wishes the payment to be made.
   (ii) adding component identifying which of a plurality of accounts 30 associated with the second customer 24 the first customer 14 wants to credit with the payment.
   (iii) adding a component identifying the method of payment to be made to the recipient. For example, electronic transfer, credit of associated account 30 held in the recipients name with carrier 28 or by legal tender.
In the case of (i) and (ii) above, payment processing will need to be modified in a manner as would be apparent to the person skilled in the art.
The communications message 32 may also be adapted to simply include identification of the intended recipient. In such an arrangement, the amount to be transferred can be an attribute of, or suffix to, the telephone line, e-mail address, or other intended destination of the communications message. To elaborate, a plurality of telephone lines could be used with each telephone line representing a different amount to be transferred. In such arrangement, the telephone number associated with the line could include as part of the dialled digits, the amount to be transferred (eg. shortcode 810 could be used by customers to transfer $10). This arrangement then provides the customer with an easy reference to assist them in ensuring that they send the communications message using the telephone line corresponding to the amount that they wish to transfer.
The communications message 32 may be yet further adapted to simply identify the amount to be transferred. In such an arrangement the telephone number dialled may be a combination of a short code number and the unique communication identifier for the intended recipient of the amount to be transferred. Payments facilitator 20 then operates to parse the dialled telephone number to obtain the unique communication identifier and convert it into a native format for use in subsequent processing.
In situations where the first customer 14 enters in details of the amount to be transferred and/or the unique communication identifier using the telephone keypad, the system as described may be adapted to allow the first customer 14 to do so without needing to wait for the prompts from the automated system. Instead, the first customer 14 may be able to split the dialled tones representing the amount to be transferred form the dialled tones representing the unique communication identifier using an appropriate separator key—such as the “*” or “#” keys.
Command 35 may take the form of a data packet in a format specific to the billing system 18, an SMS message, an e-mail or a telephone call utilising DTMF signals to indicate the amount to be transferred and identify the intended recipient.
The communications message 32 and command 35 may also be encrypted. In such situations at least the first communications device 22, the payments facilitator 20 and the billing system 18 (as appropriate) must be equipped with means for encrypting and decrypting messages.
In a modification of the fourth example described, the second customer 24 may also be asked to specify which account 30 the money is to be paid in to (in situations where the second customer 24 has more than one account 30). Optionally, the first customer 14 may be asked to confirm that it is acceptable for the money to be paid into the account 30 specified by the second customer 24.
The payments facilitator 20 may be adapted to arrange for automatic update of the tariff look-up table 34 in the event of a change in any of the tariff rates defined by the carrier 28.
The amount credited to the account 30 of the second customer 24 or the amount paid to the merchant 38, may be subject to commissions or transaction costs as levied by payments facilitator 20 which increase the total amount debited. The amount of commission or transaction cost may vary depending on such factors as amount of payment to be made, recipient and/or method of payment.
Other mechanisms than automatic caller identification can be used to establish the unique communication identifier of the first communication device 22.
The second customer 24 need not own or operate a second communications device 26. In such situations, the second customer 24 needs to have some other attribute to facilitate identification and communication.
The payments facilitator 20 and billing system 18 may form part of a larger computer system operated by the telecommunications carrier.

It should be further appreciated by the person skilled in the art that variations and combinations of features described above, not being alternatives or substitutes, can be combined to form yet further embodiments falling within the intended scope of the invention.

1. A system for facilitating payment via a communications network using value accredited to a customer of the communications network, the system comprising:
a first communications device owned and/or operated by the customer, the first communications device operable via the communications network;
a recipient;
a billing system associated with the communications network, both the customer and the recipient having at least one account recorded with the billing system; and
a payments facilitator,
where, when the payments facilitator receives a communications message from the customer, the communications message being sent by means of the first communications device, the payments facilitator operates to instruct the billing system to debit an amount to be paid to the recipient from the customer's at least one account and operates to instruct the billing system to credit the amount to be paid to the recipient to the recipient's at least one account.

2. A system for facilitating payment via a communications network using value accredited to a customer of the communications network, the system comprising:
a first communications device owned and/or operated by the customer, the first communications device operable via the communications network;
a payment facilitator;
a billing system associated with the communications network, both the customer and the payment facilitator having at least one account recorded with the billing system; and
a recipient,
where, when the payments facilitator receives a communications message from the customer, the communications message being sent by means of the first communications device, the payments facilitator operates to instruct the billing system to debit an amount to be paid to the recipient from the customer's at least one account and operates to instruct the billing system to credit the amount to be paid to the recipient to the payments facilitator's at least one account and, wherein, the payments facilitator then operates to make a payment to the recipient equal to the amount to be paid.

3. A system for facilitating payment according to claim 2, where the communications message identifies a method of payment, the payments facilitator thereafter operable to make a payment to the recipient equal to the amount to be paid according to the identified method of payment.

4. A system for facilitating payment according to claim 3, where the method of payment is one of the following: electronic transfer; cheque; legal tender.

5. A system for facilitating payment according to any preceding claim, where the communications message identifies the amount to be paid to the recipient, the payments facilitator thereafter operable to debit the identified amount to be paid to the recipient from the customer's at least one account and operable to instruct the billing system to credit the identified amount to be paid to the recipient to the recipient's at least one account.

6. A system for facilitating payment according to any one of claims 1 to 4, where the payments facilitator receives the communications message via a destination address, the destination address associated with a predetermined amount to be paid to the recipient, wherein the payments facilitator thereafter operates to debit the predetermined amount to be paid to the recipient from the customer's at least one account and operates to instruct the billing system to credit the predetermined amount to be paid to the recipient to the recipient's at least one account.

7. A system for facilitating payment via a communications network using value accredited to a customer of the communications network, the system comprising:
a first communications device owned and/or operated by the customer, the first communications device operable via the communications network;
a recipient;
a billing system associated with the communications network, both the customer and the recipient having at least one account recorded with the billing system; and
a payments facilitator,
where, when the payments facilitator receives a communications message from the customer, the communications message being sent by means of the first communications device, the payments facilitator communicates with the recipient to specify an amount to be transferred, the payments facilitator then operable to instruct the billing system to debit the specified amount from the customer's at least one account and operable to instruct the billing system to credit the specified amount to the recipient's at least one account.

8. A system for facilitating payment according to claim 7, where the payments facilitator is operable to communicate with the customer to confirm that the amount specified by the recipient is an acceptable amount to be transferred and where, upon confirmation, the payments facilitator operates to instruct the billing system to debit the specified amount from the customer's at least one account and operates to instruct the billing system to credit the specified amount to the recipient's at least one account.

9. A system for facilitating payment according to claim 7 or claim 8, where, when the payments facilitator communicates with the recipient, the recipient also specifies the recipient's at least one account with the billing system to which the amount to be paid to the recipient is to be paid to, the payments facilitator then operable to instruct the billing system to credit the specified amount to the recipient's specified at least one account.

10. A system for facilitating payment according to claim 9, where, the payments facilitator is operable to communicate with the customer to confirm that the at least one account specified by the recipient is an acceptable account for the specified amount to be transferred to and where, upon confirmation, the payments facilitator operates to instruct the billing system to credit the specified amount to the recipient's specified at least one account.

11. A system for facilitating payment according to claim 8 or claim 10, where the payments facilitator communicates with the customer via a first communications message and the customer provides confirmation to the payments facilitator via a second communications message.

12. A system for facilitating payment according to any one of claims 8, 10 or 11, where the customer provides confirmation to the payments facilitator via a communications message which includes a unique confirmation identifier.

13. A system for facilitating payment according to claim 12, where the unique confirmation identifier is a personal identification number or a password.

14. A system for facilitating payment according to any one of claims 8 or 10 to 13, where the customer is required to provide confirmation to the payments facilitator within a predetermined time period commencing from the time the payments facilitator communicates with the customer, the payments facilitator only operable to instruct the billing system to debit the specified amount from the customer's at least one account and operable to instruct the billing system to credit the specified amount to the recipient's at least one account, upon receiving confirmation within the predetermined time period.

15. A system for facilitating payment according to claim 1 or claims 7 to 14, where the communications message identifies the recipient, the payments facilitator thereafter operable to instruct the billing system to credit the amount to be paid to the recipient to the identified recipient's at least one account.

16. A system for facilitating payment according to claim 1 or claims 7 to 14, where the payments facilitator receives the communications message via a destination address, the destination address either associated with, or including, means for identifying the recipient, the payments facilitator thereafter operable to instruct the billing system to credit the amount to be paid to the recipient to the identifiable recipient's at least one account.

17. A system for facilitating payment according to claim 15 or claim 16 where the payments facilitator identifies the recipient by comparing a unique merchant identifier embodied in the communications message, associated with the destination address, or included within the destination address, as appropriate, against unique merchant identifiers stored in a merchant look-up table, each unique merchant identifier in the merchant look-up table being associated with further information in respect of the merchant.

18. A system for facilitating payment according to any preceding claim, where the instruction to the billing system to debit the amount to be paid takes the form of a command representative of the customer having initiated a communication using the first communication device having a tariff rate closest to the amount to be paid to the recipient.

19. A system for facilitating payment according to claim 18, where the payments facilitator determines the communication having a tariff rate closest to the amount to be paid to the recipient by referring to a tariff look-up table comprising details of at least one communication tariff rate presently set by an operator of the communications network.

20. A system for facilitating payment according to claim 19, where the tariff look-up table is automatically updated with details of communication tariff rates presently set by the operator of the communications network when the operator of the communications network changes any of the communication tariff rates, or adds or deletes a communication tariff rate.

21. A system for facilitating payment according to any preceding claim, where the instruction to the billing system to credit the amount to be paid to the recipient takes the form of a command representative of the recipient having made a payment to the communication network's operator equal to the amount to be paid to the recipient.

22. A system for facilitating payment according to any preceding claim, where the recipient owns and/or operates a second communications device, the recipient able to be identified by means of a unique identifier assigned to the second communications device.

23. A system for facilitating payment according to any preceding claim, where the communications message identifies which of the customer's at least one account the amount to be paid to the recipient is to be debited from, the payments facilitator thereafter operable to instruct the billing system to debit the amount to be paid to the recipient from the customer's account as identified in the communications message.

24. A system for facilitating payment according to claim 1, claim 5 or claim 6 as dependent on claim 1, or any one of claims 11 to 23, where the communications message identifies which of the recipient's at least one account the amount to be paid to the recipient is to be credited to, the payments facilitator thereafter operable to instruct the billing system to credit the amount to be paid to the recipient to the recipient's account as identified in the communications message.

25. A system for facilitating payment according to any preceding claim where the first communications device is one of the following: a computer; a mobile phone; a fixed phone; a pager.

26. A system for facilitating payment according to any preceding claim, where the communications network is one of the following: a mobile phone network; a telephone network; a data communications network.

27. A system for facilitating payment according to any preceding claim, where the communications message is one of the following formats: a Short Message Service message; an e-mail message; a voice message; a set of DTMF tones.

28. A system for facilitating payment according to any preceding claim, where the instructions to the billing system take at least one of the following formats: a Short Message Service message; an e-mail message; a voice message; a set of DTMF tones.

29. A system for facilitating payment according to any preceding claim, where the instructions and/or communications messages are encrypted.

30. A system for facilitating payment according to any preceding claim, where the payments facilitator is further operable to instruct the billing system to debit a further amount from the customer's at least one account representative of commission and/or transaction costs.

31. A system for facilitating payment according to claim 30, where the payments facilitator operates to instruct the billing system to debit the amount to be paid to the recipient and the further amount representative of commission and/or transaction costs in the one instruction.

32. A system for facilitating payment according to any preceding claim, where the payments facilitator also operates the communications network.

33. A payments facilitator for use within a system for facilitating payment via a communications network using value accredited to a customer of the communications network, the system comprising:
a first communications device owned and/or operated by the customer, the first communications device operable via the communications network;
a recipient; and
a billing system associated with the communications network, both the customer and the recipient having at least one account recorded with the billing system,
where the payments facilitator, upon receipt of a communications message from the customer, the communications message being sent by means of the first communications device, operates to instruct the billing system to debit an amount to be paid to the recipient from the customer's at least one account and operates to instruct the billing system to credit the amount to be paid to the recipient to the recipient's at-least one account.

34. A payments facilitator for use within a system for facilitating payment via a communications network using value accredited to a customer of the communications network, the system comprising:
a first communications device owned and/or operated by the customer, the first communications device operable via the communications network;
a recipient; and
a billing system associated with the communications network, both the customer and the payment facilitator having at least one account recorded with the billing system,
where the payments facilitator, upon receipt of a communications message from the customer, the communications message being sent by means of the first communications device, operates to instruct the billing system to debit an amount to be paid to the recipient from the customer's at least one account; operates to instruct the billing system to credit the amount to be paid to the recipient to the payment facilitator's at least one account; and operates to make a payment to the recipient equal to the amount to be paid.

35. A payments facilitator according to claim 34, where upon receipt of a communications message identifying a method of payment, operates to make a payment to the recipient equal to the amount to be paid according to the identified method of payment.

36. A payments facilitator according to claim 35, where the method of payment is one of the following: electronic transfer; cheque; legal tender.

37. A payments facilitator according to any one of claims 33 to 36, operable to identify the amount to be paid to the recipient from the communications message and, thereafter, operable to debit the identified amount to be paid to the recipient from the customer's at least one account and operable to instruct the billing system to credit the identified amount to be paid to the recipient to the recipient's at least one account.

38. A payments facilitator according to any one of claims 33 to 36, operable to identify a predetermined amount to be paid to the recipient from a destination address via which the communications message is received and, thereafter, operable to debit the predetermined amount to be paid to the recipient from the customer's at least one account and operable to instruct the billing system to credit the predetermined amount to be paid to the recipient to the recipient's at least one account.

39. A payments facilitator for use in a system for facilitating payment via a communications network using value accredited to a customer of the communications network, the system comprising:
a first communications device owned and/or operated by the customer, the first communications device operable via the communications network;
a recipient; and
a billing system associated with the communications network, both the customer and the recipient having at least one account recorded with the billing system,
where the payments facilitator, upon receipt of a communications message from the customer, the communications message being sent by means of the first communications device, operates to communicate with the recipient to specify an amount to be transferred and, thereafter, operates to instruct the billing system to debit the specified amount from the customer's at least one account and operates to instruct the billing system to credit the specified amount to the recipient's at least one account.

40. A payments facilitator according to claim 39, operable to communicate with the customer to confirm that the amount specified by the recipient is an acceptable amount to be transferred and, only upon confirmation, operable to instruct the billing system to debit the specified amount from the customer's at least one account and operate to instruct the billing system to credit the specified amount to the recipient's at least one account.

41. A payments facilitator according to claim 39 or claim 40, where, when communicating with the recipient, the recipient also specifies the recipient's at least one account with the billing system to which the amount to be paid to the recipient is to be paid to, operates to instruct the billing system to credit the specified amount to the recipient's specified at least one account.

42. A payments facilitator according to claim 41, operable to communicate with the customer to confirm that the at least one account specified by the recipient is an acceptable account for the specified amount to be transferred to and where, upon confirmation, operates to instruct the billing system to credit the specified amount to the recipient's specified at least one account.

43. A payments facilitator according to claim 40 or 42, operable to communicate with the customer via a first communications message and receive confirmation from the customer via a second communications message.

44. A payments facilitator according to any one of claims 40, 42 or 43, operable to validate confirmation from the customer upon the customer providing a unique confirmation identifier.

45. A payments facilitator according to any one of claims 40 or 42 to 44, operable to validate confirmation from the customer upon receiving confirmation with a predetermined time period commencing from the time of communication with the customer and, upon valid confirmation, operable to instruct the billing system to debit the specified amount from the customer's at least one account and operable to instruct the billing system to credit the specified amount to the recipient's at least one account.

46. A payments facilitator according to claim 33 or claims 39 to 45, operable to identify the recipient from the communications message and, thereafter, operable to instruct the billing system to credit the amount to be paid to the recipient to the identified recipient's at least one account.

47. A payments facilitator according to claim 33 or claims 39 to 45, operable to identify the recipient from a destination address via which the communications message is received and, thereafter, operable to instruct the billing system to credit the amount to be paid to the recipient to the identified recipient's at least one account.

48. A payments facilitator according to claim 46 or claim 47, operable to identify the recipient by comparing a unique merchant identifier embodied in the communications message, associated with the destination address, or included within the destination address, as appropriate, against unique merchant identifiers stored in a merchant look-up table, each unique merchant identifier in the merchant look-up table being associated with further information in respect of the merchant.

49. A payments facilitator according to any one of claims 33 to 48, operable to instruct the billing system to debit the amount to be paid by means of a command representative of the customer having initiated a communication using the first communication device having a tariff rate closest to the amount to be paid to the recipient.

50. A payments facilitator according to claim 49, operable to determine the communication having a tariff rate closest to the amount to be paid to the recipient by referring to a tariff look-up table comprising details of at least one communication tariff rate presently set by an operator of the communications network.

51. A payments facilitator according to claim 50, operable to automatically update the tariff look-up table with details of communication tariff rates presently set by the operator of the communications network when the operator of the communications network changes any of the communication tariff rates, or adds or deletes a communication tariff rate.

52. A payments facilitator according to any one of claims 33 to 51, operable to instruct the billing system to credit the amount to be paid to the recipient by means of a command representative of the recipient having made a payment to the communication network's operator equal to the amount to be paid to the recipient.

53. A payments facilitator according to any one of claims 33 to 52, operable to identify from the communications message which of the customer's at least one account the amount to be paid to the recipient is to be debited from and operable to instruct the billing system to debit the amount to be paid to the recipient from the customer's identified account.

54. A payments facilitator according to any one of claim 33, claim 37 or claim 38 as dependent on claim 33, or any one of claims 43 to 53, operable to identify from the communications message which of the recipient's at least one account the amount to be paid to the recipient is to be credited to and operable to instruct the billing system to credit the amount to be paid to the recipient to the recipient's identified account.

55. A payments facilitator according to any one of claims 33 to 54, operable to decrypt communications messages.

56. A payments facilitator according to any one of claims 33 to 55, operable to encrypt instructions.

57. A payments facilitator according to any one of claims 33 to 56, operable to instruct the billing system to debit a further amount from the customer's at least one account representative of commission and/or transaction costs.

58. A payments facilitator according to claim 57, operable to instruct the billing system to debit the amount to be paid to the recipient and the further amount representative of commission and/or transaction costs in the one instruction.

59. A method of facilitating payment via a communications network using value accredited to a customer of the communications network, the method comprising the steps of:
(a) receiving a communications message from the customer sent by means of a first communications device operable via the communications network;
(b) instructing a billing system associated with the communications network to debit an amount to be paid to a recipient from the customer's at least one account recorded with the billing system; and
(c) instructing the billing system to credit the amount to be paid to the recipient to the recipient's at least one account recorded with the billing system.

60. A method of facilitating payment via a communications network using value accredited to a customer of the communications network, the method comprising the steps of:
(a) receiving a communications message from the customer sent by means of a first communications device operable via the communications network;
(b) instructing a billing system associated with the communications network to debit an amount to be paid to a recipient from the customer's at least one account recorded with the billing system;
(d) instructing the billing system to credit the amount to be paid to the recipient to an account recorded with the billing system, the account being owned by a third party; and
(e) arranging payment of the amount to be paid to be made by the third party to the recipient.

61. A method according to claim 60, including the step of receiving details specifying the method of payment, step (e) then being performed in accordance with the specified method of payment.

62. A method according to any one of claims 59 to 61, including the step of identifying the amount to be paid to the recipient from the communications message.

63. A method according to any one of claims 59 to 61, including the step of identifying the amount to be paid to the recipient from the destination address via which the communications message is received.

64. A method according to claim 59, including the step of communicating with the recipient to specify the amount to be paid to the recipient.

65. A method according to claim 64, including the step of communicating with the customer to confirm that the amount specified by the recipient is an acceptable amount to be transferred and, upon confirmation, proceeding with steps (b) and (c).

66. A method according to claim 64 or claim 65, including the step of receiving details from the recipient specifying the recipient's at least one account with the billing system to which the amount to be paid to the recipient is to be paid to, step (c) then operating to make payment to the recipient's specified at least one account.

67. A method according to claim 66, including the step of communicating with the customer to confirm that the recipient's specified at least one account is an acceptable account for the specified amount to be transferred to and, upon confirmation, proceeding to perform step (c) with payment being made to the recipient's specified at least one account.

68. A method according to claim 65 or 67, including the step of validating confirmation upon receiving a unique confirmation identifier from the customer.

69. A method according to claim 65, 67 or 68, including the step of validating confirmation upon receiving confirmation from the customer within a predetermined time period commencing from the time of first communicating with the customer.

70. A method according to claim 59 or claims 64 to 69, including the step of identifying the recipient from the communications message.

71. A method according to claim 59 or claims 64 to 69, including the step of identifying the recipient from the destination address via which the communications message is received.

72. A method according to claim 70 or claim 71, including the step of comparing a unique identifier embodied in the communications message, associated with the destination address, or included within the destination address, as appropriate, against unique merchant identifiers stored in a merchant look-up table, each unique merchant identifier in the merchant look-up table being associated with further information in respect of the merchant.

73. A method according to any one of claims 59 to 72, including the step of determining a communication having a tariff rate closest to the amount to be paid to the recipient by reference to a tariff look-up table comprising details of at least one communication tariff rate presently set by an operator of the communications network, step (b) then being operable to instruct the billing system to debit the amount to be paid by means of a command representative of the customer having initiated a communication using the first communication device having the determined tariff rate.

74. A method according to claim 73, including the step of automatically updating the tariff look-up table with details of communication tariff rates presently set by the operator of the communications network when the operator of the communications network changes any of the communication tariff rates, or adds or deletes a communication tariff rate.

75. A method according to any one of claim 59 or claims 64 to 74, including the step of receiving details from the customer specifying which of the customer's at least one account the amount to be paid to the recipient is to be debited from, step (b) then operable to debit the amount to be paid from the specified account.

76. A method according to any one of claim 59, claim 62 or claim 63 as dependent on claim 59, or claims 68 to 75, including the step of receiving details from the customer specifying which of the recipient's at least one account the amount to be paid to the recipient is to be credited to, step (c) then operable to credit the specified account.

77. A method according to any one of claims 59 to 76, including the step of encrypting the communication message.

78. A method according to any one of claims 59 to 77, including the step of encrypting the instructions.

79. A method according to any one of claims 59 to 78, including the step of instructing the billing system to debit a further amount from the customer's at least one account representative of commission and/or transaction costs.

80. A communications network for use in a system for facilitating payment via the communications network using value accredited to a customer of the communications network, the communications network associated with a billing system in which both the customer and a recipient have at least one account recorded therewith, the communications network operable to transmit a communications message between the customer and a payments facilitator, receive instructions from the payments facilitator to debit an amount to be paid to the recipient from the customer's at least one account and receive instructions to credit the amount to be paid to the recipient to the recipient's at least one account.

81. A communications network for use in a system for facilitating payment via the communications network using value accredited to a customer of the communications network, the communications network associated with a billing system in which both the customer and the payments facilitator have at least one account recorded therewith, the communications network operable to transmit a communications message between the customer and a payments facilitator, receive instructions from the payments facilitator to debit an amount to be paid to the recipient from the customer's at least one account and receive instructions to credit the amount to be paid to the recipient to the payments facilitator at least one account, the payments facilitator thereafter operating to make payment to the recipient equal to the amount credited. facilitator and customer to verify that the specified account the recipient has requested the amount be paid into is an acceptable account.

74. A communications network according to any one of claims 69 to 73, operable to automatically send updated details of applicable communication tariff rates upon any changes, additions or deletions to such communication tariff rates

75. A communications network according to any one of claims 69 to 74, operable to receive an instruction to debit a further amount representative of commission and/or transaction costs of the payments facilitator from the customer's at least one account.

76. A system for facilitating payment via a communications network using value accredited to a customer of the communications network substantially as described herein with reference to the drawings.

77. A payments facilitator for use in a system for facilitating payment via a communications network using value accredited to a customer of the communications network substantially as described herein with reference to the drawings.

78. A communications network for use in a system for facilitating payment via a communications network using value accredited to a customer of the communications network substantially as described herein with reference to the drawings.

79. A method of facilitating payment via a communications network using value accredited to a customer of the communications network substantially as described herein with reference to the drawings.

82. A communications network according to claim 80 or claim 81, where the communication message is sent by the customer to a destination address of the communications network allocated to the payments facilitator, the payments facilitator capable of identifying an amount to be paid to the recipient and the identity of the recipient from the destination address and/or the communication message.

83. A communications network for use in a system for facilitating payment via the communications network using value accredited to a customer of the communications network, the communications network associated with a billing system in which both the customer and a recipient have at least one account recorded therewith, the communications network operable to transmit a communication message between the customer and a payments facilitator, transmit a further exchange of communication messages between payments facilitator and recipient and, thereafter, operable to receive instructions from the payments facilitator to debit an amount to be paid to the recipient from the customer's at least one account as determined from the further exchange of communication messages and receive instructions to credit the amount to be paid to the recipient as determined by the further exchange of communication messages to the recipient's at least one account.

84. A communications network according to claim 83, operable to send an additional exchange of communication messages between payments facilitator and customer to verify that the amount to be paid to the recipient as determined by the further exchange of communication messages is an acceptable amount.

85. A communications network according to claim 83 or claim 84, operable to send a supplementary exchange of communication messages between payments facilitator and customer to verify that the specified account the recipient has requested the amount be paid into is an acceptable account.

86. A communications network according to any one of claims 80 to 85, operable to automatically send updated details of applicable communication tariff rates upon any changes, additions or deletions to such communication tariff rates

87. A communications network according to any one of claims 80 to 86, being a mobile phone network; a telephone network; a data communications network.

88. A communications network according to any one of claims 80 to 87, operable to transmit communications messages in at least one of the following formats: a Short Message Service message; an e-mail message; a voice message; a set of DTMF tones.

89. A communications network according to any one of claims 80 to 88, operable to receive instructions in at least one of the following formats: a Short Message Service message; an e-mail message; a voice message; a set of DTMF tones.

90. A communications network according to any one of claims 80 to 89, operable to transmit communications messages and receive instructions in an encrypted format.

91. A communications network according to any one of claims 80 to 90, operable to receive an instruction to debit a further amount representative of commission and/or transaction costs of the payments facilitator from the customer's at least one account.

92. A system for facilitating payment via a communications network using value accredited to a customer of the communications network substantially as described herein with reference to the drawings.

93. A payments facilitator for use in a system for facilitating payment via a communications network using value accredited to a customer of the communications network substantially as described herein with reference to the drawings.

94. A communications network for use in a system for facilitating payment via a communications network using value accredited to a customer of the communications network substantially as described herein with reference to the drawings.

95. A method of facilitating payment via a communications network using value accredited to a customer of the communications network substantially as described herein with reference to the drawings.
